(19) United States
(12) Patent Application Publication
(10) Pub. No.: US 2018/0197110 A1
(43) Pub. Date: Jul. 12, 2018

(54) Metrics to Train Machine Learning Predictor for NoC Construction

(71) Applicant: NetSpeed Systems, Inc., San Jose, CA (US)

(72) Inventors: Nishant RAO, San Jose, CA (US); Pier Giorgio RAPONI, San Jose, CA (US); Sailesh KUMAR, San Jose, CA (US)

(73) Assignee: NetSpeed Systems, Inc.

(21) Appl. No.: 15/404,159

(22) Filed: Jan. 11, 2017

(51) Int. Cl. G06N 99/00; H04L 12/24

(52) U.S. Cl. CPC G06N 99/005; H04L 41/12

(57) ABSTRACT

The present disclosure is directed to machine learning (ML) based network-on-chip (NoC) construction. Methods, systems, and computer readable mediums of the present disclosure utilize a ML process for making decisions to evaluate whether a NoC design finally obtained is actually the most optimal and efficient one or not during construction of a NoC. ML process for the construction of the NoC maximizes entropy for one or more features of the NoC. In an example implementation, the present disclosure provides a machine learning algorithm/predictor that receives inputs in the form of features that are extracted from a specification, a plurality of mapping strategies, a quality metrics) obtained by implementing a mapping strategy on the NoC, and one or more performance function (user requirement) to generate an output showing whether the selected strategy for the construction of the NoC yields a good result or a bad result based on learning/training.

### TECHNICAL FIELD

Methods and example implementations described herein are generally directed to machine learning, and more specifically, to applying trained machine learning (ML) for making decisions during Network-on-Chip (NoC) construction.

### RELATED ART

The number of components on a chip is rapidly growing due to increasing levels of integration, system complexity and shrinking transistor geometry. Complex System-on-Chips (SoCs) may involve a variety of components e.g., processor cores, DSPs, hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies 100 in which the routers can connect to one another to create the system network. Bi-directional rings (as shown in FIG. 1A, 2-D (two dimensional) mesh (as shown in FIG. 1B), and 2-D Taurus (as shown in FIG. 1C) are examples of topologies in the related art. Mesh and Taurus can also be extended to 2.5-D (two and half dimensional) or 3-D (three dimensional) organizations. FIG. 1D shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has its ports used, one connecting to the router 112 at the top layer and another connecting to the router 110 at the bottom layer. Routers 110 and 112 are at the bottom and top mesh layers respectively and therefore have only the upper facing port 113 and the lower facing port 114 respectively connected.

Packets are message transport units for intercommunication between various components. Routing involves identifying a path that is a set of routers and physical links of the network over which packets are sent from a source to a destination. Components are connected to one or multiple ports of one or multiple routers; with each such port having a unique identification (ID). Packets can carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2A pictorially illustrates an example of XY routing 200 in a two dimensional mesh. More specifically, FIG. 2A illustrates XY routing from node ‘34’ to node ‘00’. In the example of FIG. 2A, each component is connected to only one port of one router. A packet is first routed over the X-axis till the packet reaches node ‘04’ where the X-coordinate of the node is the same as the X-coordinate of the destination node. The packet is next routed over the Y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is a header flit, which holds information about this packet's route and key message level info along with payload data and sets up the routing behavior for all subsequent flits associated with the message. Optionally, one or more body flits follows the header flit, containing remaining payload of data. The final flit is a tail flit, which, in addition to containing last payload, also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Taurus NoC, there exist multiple route paths of equal length or number of hops between any pair of source and destination nodes. For example, in FIG. 2B, in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3A illustrates a two layer NoC 300. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3B, a host connected to a router from each layer, R1 and R2 respectively, is illustrated. Each router is connected to other routers in its layer using directional ports 301, and is connected to the host using injection and ejection ports 302. A bridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, and so on. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

System on Chips (SoCs) are becoming increasingly sophisticated, feature rich, and high performance by integrating a growing number of standard processor cores, memory and I/O subsystems, and specialized acceleration IPs. To address this complexity, NoC approach of connecting SoC components is gaining popularity. A NoC can provide connectivity to a plethora of components and interfaces and simultaneously enable rapid design closure by being automatically generated from a high level specification. The specification describes interconnect requirements of SoC in terms of connectivity, bandwidth, and latency. The specification can include constraints such as Bandwidth/Quality of Service (QoS)/latency attributes that are to be met by the NoC, and can be, in various software formats, depending on the design tools, utilized. Once NoC is generated through the use of design tools on the specification to meet specification requirements, physical architecture can be implemented either by manufacturing a chip layout to facilitate NoC or by generation of a register transfer level (RTL) for execution on a chip to emulate the generated NoC, depending on desired implementation. Specifications may be in common power format (CPF), Unified Power Format (UPF), or others according to the desired specification. Specifications can be in the form of traffic specifications indicating the traffic, bandwidth requirements, latency requirements, interconnections, etc depending on the desired implementation. Specifications can also be in the form of power specifications to define power domains, voltage domains, clock domains, and so on, depending on the desired implementation.

Specification can include parameters for bandwidth, traffic, jitter, dependency information, and attribute information depending on desired implementation. In addition to this, information such as position of various components, protocol information, clocking and power domains, and so on may be supplied. A NoC compiler can then use this specification to automatically design a NoC for the SoC. A number of NoC compilers were introduced in the related art that automatically synthesize a NoC to fit a traffic specification. In such design flows, synthesized NoC is simulated to evaluate performance under various operating conditions and to determine whether the specifications are met. This may be necessary because NoC-style interconnects are distributed systems and their dynamic performance characteristics under load are difficult to predict statically and can be very sensitive to a wide variety of parameters.

FIG. 4 illustrates an example system 400 with two hosts and two flows represented as an example traffic specification. Such traffic specifications are usually in the form of an edge-weighted digraph, where each node in the graph is a host in the network, and where edges represent traffic sent from one node to another. Furthermore, weights indicate bandwidth of traffic. Such specifications are sometimes annotated with latency requirements for each flow, indicating a limit on transfer time. System 400 illustrates connection between a first host such as a CPU 402 and a second host such as a memory unit 404 with two traffic flows (406 and 408) between them, wherein first flow is a ‘load request’ 406 from CPU 402 to memory 404, and second flow is ‘load data’ 408 sent back from the memory 404 to the CPU 402. This traffic flow information can be described in the specification of the NoC and used for designing and simulating the NoC.

However, specifications may have following limitations in addition to other un-cited limitations. The first limitation of the specification is that the information included therein may not be enough for satisfying dynamic or real time requirements for hosts of SoC through the NoC. Though the specification can include information on external dependencies between ports of different hosts, information on internal dependencies of hosts and/or messages/packets are not included. The second limitation of flow level specification is that network simulations performed, such as using point to point traffic represented by the flows in flow level specification, may not be sufficient enough, or may be inaccurate because of other missing information such as inter-dependency information.

Further, it is also a known issue that based on requirements of the system or users of the system, specification may have to be configured and/or altered to match expectations or real time requirements such as area specification or cost specification or traffic specifications or power specifications. Thus, frequent change in specification requirements may require a more flexible/customized NoC as the system requirements may vary from one system to other. This further leads to substantial time consumption in revising or altering the specification received and then again checking for achievement of the desired system requirements.

Also, performance of an NoC design depends on a number of parameters such as area, bandwidth, latency, among others, which parameters change on real-time basis and are generally based on user requirements, all of which need to be kept in mind while designing an NoC, and is time-consuming and expensive given the number of iterations/changes that are required to be done in order to obtain a design that meets all the required constraints. For example, while designing a NoC, user may focus on bandwidth parameters (e.g., bandwidth of agents) or on cost parameters (e.g., number of wires) or on area parameters (e.g. number of buffers), among other like parameters or combinations thereof, which are dynamic or real-time in nature. Therefore, in view of the above limitations discussed, it is difficult to evaluate whether an NoC design finally obtained is actually the most optimal and efficient one or not and whether the design is satisfactory to user requirements in terms of area or cost or traffic or power.

Therefore, there exists a need for methods, systems, and computer readable mediums for utilizing a trained machine learning (ML) process for making decisions to evaluate whether a NoC design that is finally obtained is actually the most optimal and efficient one or not during construction of a NoC, and that it is actually as per user requirements.

### SUMMARY

Aspects of the present disclosure relate to methods, systems, and computer readable mediums for utilizing a trained machine learning (ML) process for making decisions to evaluate whether a NoC design that is finally obtained is actually the most optimal, efficient one or not during construction of a NoC, and are actually as per user requirements. In example implementations, entropy can be maximized for the extracted features through use of randomization functions on the parameters of the NoC specification so that when fed into the machine learning process, a larger space of possible values for each part of the feature vector can be explored.

An aspect of the present disclosure relates to a method for construction of a machine learning process for generating a NoC, wherein the method can extract a first vector of features representing at least one NoC specification, the first vector of features representative of a space of possible NoC specifications. The method of the present disclosure can further execute training on one or more classifiers based on the first vector of features in order to obtain a second vector that is indicative of a plurality of NoC generation strategies and a quality metric. The method of the present disclosure can further generate a machine learning process for generating the NoC from the one or more classifiers and by utilizing at least one performance function. The generated machine learning process can process a second NoC specification to generate the NoC by using at least one strategy selected from the plurality of NoC generation strategies that maximizes the quality metric. Alternatively, the generated machine learning process can also process a second NoC specification and provide a vector of strategies that presents an indication as to whether the provided vector of strategies meets the threshold for the quality metric.

In an example implementation, the quality metric can be based on the performance function and can be based on at least one of a bandwidth function, a latency function, a cost function, or an area function.

In an example implementation, the method of executing training on the one or more classifiers can further produce a database of generated NoCs or a specification, wherein each generated NoC can be associated with a validation based on the quality metric and a strategy from the plurality of NoC generation strategies. The method can further apply at least one machine learning on the database of NoCs generated so as to generate the machine learning process.

In an aspect, the method of the present disclosure can validate the machine learning process based on a subset of generated NoCs from the database, and test the machine learning process against another subset of generated NoCs that are missing in the database.

In an aspect, the method of the present disclosure can integrate the machine learning process into a software tool that is configured to generate the NoC from a NoC specification.

In an aspect, the present disclosure relates to a system for construction of a machine learning process for generating a Network on Chip (NoC). The system includes an extraction module and an execution module, wherein the extraction module can extract a first vector of features representing at least one NoC specification, and wherein the first vector of features can be representative of a space of possible NoC specifications. The execution module, on the other hand, can execute training on one or more classifiers based on the first vector of features to obtain a second vector that is indicative of a plurality of NoC generation strategies and a quality metric. The generation module can generate a machine learning process for generating the NoC from the one or more classifiers and by utilizing at least one performance function. The machine learning process generated can further process a second NoC specification to generate the NoC by using at least one strategy selected from the plurality of NoC generation strategies that maximizes the quality metric, or process the second NoC specification and a provided vector of strategies so as to provide an indication as to whether the provided vector of strategies meets a threshold for the quality metric.

In an aspect, the system can further include an integration module that can integrate the machine learning process into a software tool that is configured to generate NoC from an input NoC specification.

In an aspect, the present disclosure relates to a non-transitory computer readable storage medium storing instructions for executing a process. The instructions can extract a first vector of features representing at least one specification, the first vector of features being representative of a space of possible NoC specifications. The instructions can execute training on one or more classifiers based on the first vector of features to obtain a second vector that is indicative of a plurality of NoC generation strategies and a quality metric. The instructions can further generate a machine learning process for generating the NoC from the one or more classifiers and by utilizing at least one performance function, wherein the generated machine learning process can process a second NoC specification so as to generate the NoC by using at least one strategy selected from the plurality of NoC generation strategies that maximizes the quality metric. Alternatively, the generated machine learning process can also process a second NoC specification and a provided vector of strategies to provide an indication as to whether the provided vector of strategies meets a threshold for the quality metric.

In an aspect, the instructions can integrate the machine learning process into a software tool configured to generate the NoC from a NoC specification.

### BRIEF DESCRIPTION OF DRAWINGS

FIGS. 1A, 1B, 1C, and 1D illustrate examples of Bidirectional ring, 2D Mesh, 2D Taurus, and 3D Mesh NoC Topologies.

FIG. 2A illustrates an example of XY routing in a related art two dimensional mesh.

FIG. 2B illustrates three different routes between a source and destination nodes.

FIG. 3A illustrates an example of a related art two layer NoC interconnect.

FIG. 3B illustrates the related art bridge logic between host and multiple NoC layers.

FIG. 4 illustrates an existing system with two hosts and two flows represented as an exemplary traffic specification.

FIG. 5 illustrates an example high-level block diagram showing construction of a machine learning process for generating a Network on Chip (NoC) in accordance with an example implementation.

FIG. 6 illustrates an example process for construction of a machine learning process for generating a Network on Chip (NoC) in accordance in accordance with an example implementation.

FIG. 7 illustrates an example method for construction of a machine learning process for generating a Network on Chip (NoC) in accordance with an example implementation.

FIG. 8 illustrates an example computer system on which example implementations may be implemented.

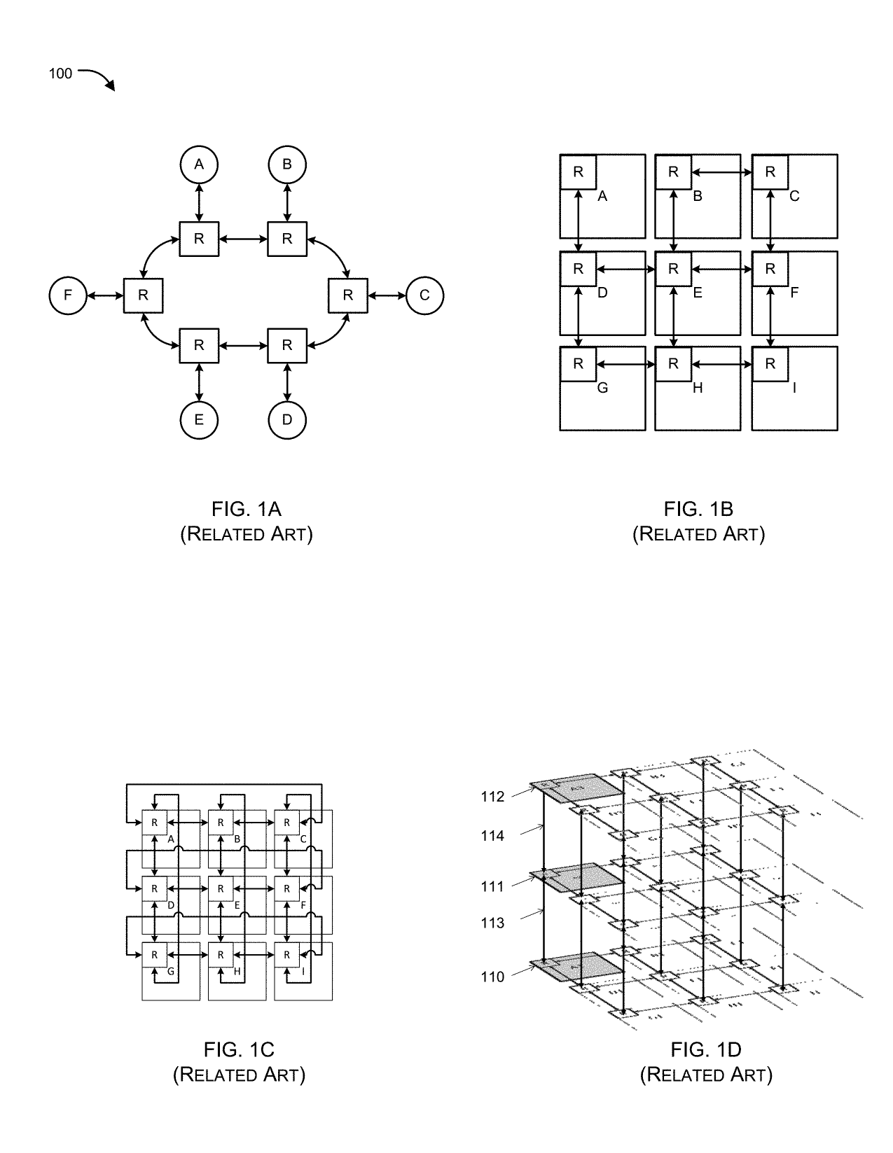

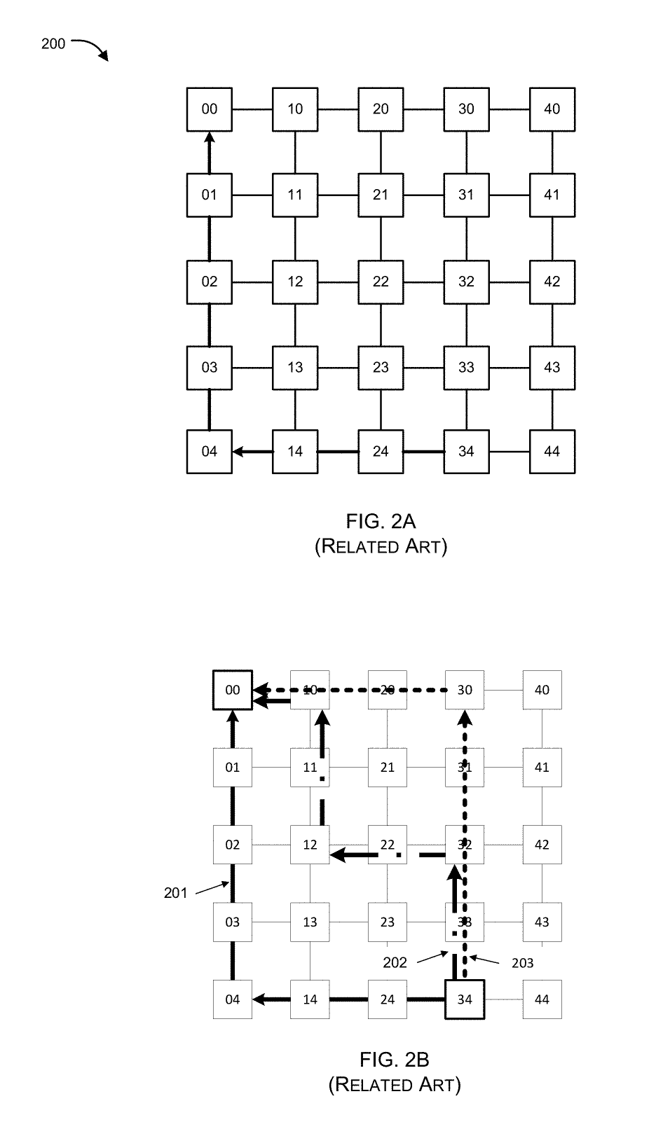

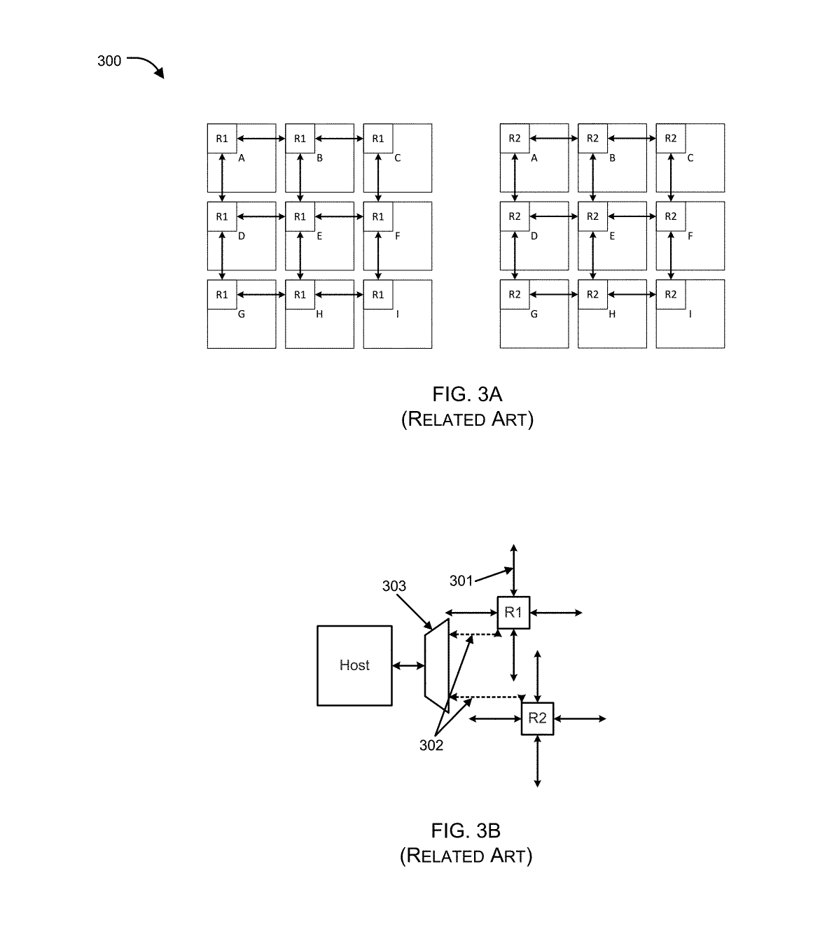

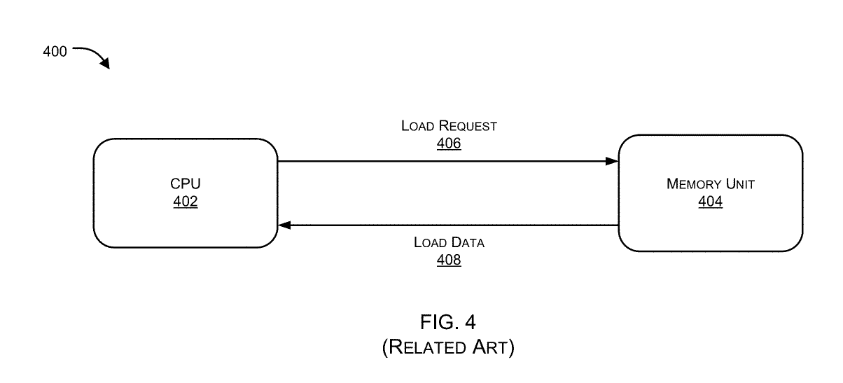

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

Network-on-Chip (NoC) has emerged as a paradigm to interconnect a large number of components on the chip. NoC is a global shared communication infrastructure made up of several routing nodes interconnected with each other using point-to-point physical links. In example implementations, a NoC interconnect is generated from a specification by utilizing design tools. The specification can include constraints such as bandwidth/Quality of Service (QoS)/latency attributes that is to be met by the NoC, and can be in various software formats depending on the design tools utilized. Once the NoC is generated through the use of design tools on the specification to meet the specification requirements, the physical architecture can be implemented either by manufacturing a chip layout to facilitate the NoC or by generation of a register transfer level (RTL) for execution on a chip to emulate the generated NoC, depending on the desired implementation. Specifications may be in common power format (CPF), Unified Power Format (UPF), or others according to the desired specification. Specifications can be in the form of traffic specifications indicating the traffic, bandwidth requirements, latency requirements, interconnections, and so on depending on the desired implementation. Specifications can also be in the form of power specifications to define power domains, voltage domains, clock domains, and so on, depending on the desired implementation.

Example implementations are directed to the utilization of machine learning based algorithms. In the related art, a wide range of machine learning based algorithms have been applied to image or pattern recognition, such as the recognition of obstacles or traffic signs of other cars, or the categorization of elements based on a specific training. In view of the advancement in power computations, machine learning has become more applicable for the generation of NoCs and for the mapping of traffic flows of NoCs.

An aspect of the present disclosure relates to a method for construction of a machine learning process for generating a NoC, wherein the method can extract a first vector of features representing at least one NoC specification, the first vector of features representative of a space of possible NoC specifications. The method of the present disclosure can further execute training on one or more classifiers based on the first vector of features in order to obtain a second vector that is indicative of a plurality of NoC generation strategies and a quality metric. The method of the present disclosure can further generate a machine learning process for generating the NoC from the one or more classifiers and by utilizing at least one performance function. The generated machine learning process can process a second NoC specification to generate the NoC by using at least one strategy selected from the plurality of NoC generation strategies that maximizes the quality metric. Alternatively, the generated machine learning process can also process a second NoC specification and provide a vector of strategies that presents an indication as to whether the provided vector of strategies meets the threshold for the quality metric.

In an example implementation, the quality metric can be based on the performance function and can be based on at least one of a bandwidth function, a latency function, a cost function, or an area function.

In an example implementation, the method of executing training on the one or more classifiers can further produce a database of generated NoCs or a specification, wherein each generated NoC can be associated with a validation based on the quality metric and a strategy from the plurality of NoC generation strategies. The method can further apply at least one machine learning on the database of NoCs generated so as to generate the machine learning process.

In an aspect, the method of the present disclosure can validate the machine learning process based on a subset of generated NoCs from the database, and test the machine learning process against another subset of generated NoCs that are missing in the database.

In an aspect, the method of the present disclosure can integrate the machine learning process into a software tool that is configured to generate the NoC from a NoC specification.

In an aspect, the present disclosure relates to a system for construction of a machine learning process for generating a Network on Chip (NoC). The system includes an extraction module and an execution module, wherein the extraction module can extract a first vector of features representing at least one NoC specification, and wherein the first vector of features can be representative of a space of possible NoC specifications. The execution module, on the other hand, can execute training on one or more classifiers based on the first vector of features to obtain a second vector that is indicative of a plurality of NoC generation strategies and a quality metric. The generation module can generate a machine learning process for generating the NoC from the one or more classifiers and by utilizing at least one performance function. The machine learning process generated can further process a second NoC specification to generate the NoC by using at least one strategy selected from the plurality of NoC generation strategies that maximizes the quality metric, or process the second NoC specification and a provided vector of strategies so as to provide an indication as to whether the provided vector of strategies meets a threshold for the quality metric.

In an aspect, the system can further include an integration module that can integrate the machine learning process into a software tool that is configured to generate NoC from an input NoC specification.

In an aspect, the present disclosure relates to a non-transitory computer readable storage medium storing instructions for executing a process. The instructions can extract a first vector of features representing at least one specification, the first vector of features being representative of a space of possible NoC specifications. The instructions can execute training on one or more classifiers based on the first vector of features to obtain a second vector that is indicative of a plurality of NoC generation strategies and a quality metric. The instructions can further generate a machine learning process for generating the NoC from the one or more classifiers and by utilizing at least one performance function, wherein the generated machine learning process can process a second NoC specification so as to generate the NoC by using at least one strategy selected from the plurality of NoC generation strategies that maximizes the quality metric. Alternatively, the generated machine learning process can also process a second NoC specification and a provided vector of strategies to provide an indication as to whether the provided vector of strategies meets a threshold for the quality metric.

In an aspect, the instructions can integrate the machine learning process into a software tool configured to generate the NoC from a NoC specification.

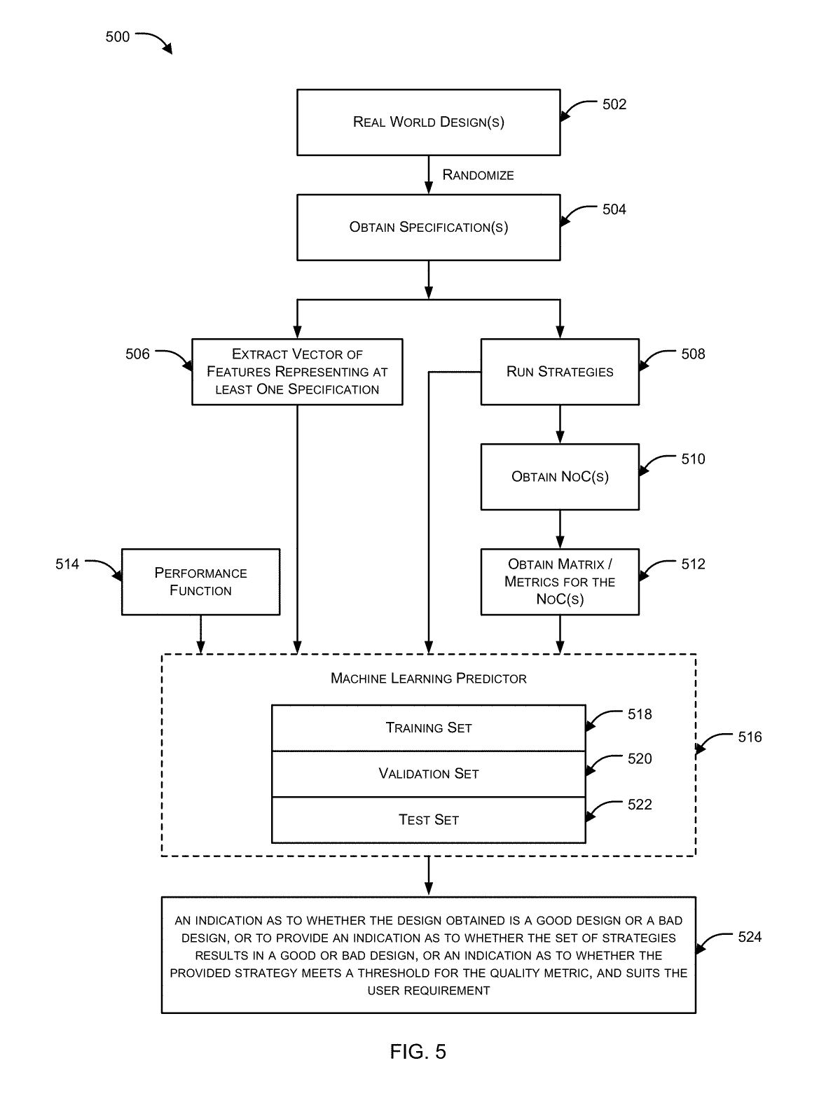

FIG. 5 illustrates an example high-level design of a system 500 for construction of a machine learning process for generating a Network on Chip (NoC) in accordance with an example implementation. In an example implementation, the present disclosure provides a machine learning algorithm/predictor that receives inputs in the form of features extracted from a specification, a plurality of mapping strategies, and metrics (e.g., quality metrics) obtained by implementing a mapping strategy on the NoC so as to generate an output showing whether the selected strategy for the construction of the NoC actually yields a good result or a bad result based on its learning/training.

In the example representation of FIG. 5, the present disclosure provides a mechanism that utilizes machine learning (ML) to making decisions in building NoCs based on the users requirement. In an example implementation, for making decisions in building NoCs, the present disclosure enables generation of real world designs 502. Such real world designs can be collected over a period of time and can represent details of the products that are currently available in the market or would be available in the market in future.

For example, details such a central processing unit (CPU) that is currently a single core and can be a multi-core in the near future or the types of memories used in the CPU, and so on, can be used. Details of products can be obtained by conducting a survey of products available in the market, for example CPU's, memory, and so on, or by changing specifications or properties or characteristic associated with the product, for example by changing the configuration of the memory in the CPU, and so on.

In an example implementation, the present disclosure can obtain specifications 504 based on real world designs generated. In a non-limiting example implementation, specifications 504 can be obtained by considering various random profiles associated with generated designs. In an example implementation, the present disclosure can obtain specifications 504 from synthetic designs. In another implementation, the present disclosure can obtain specifications 504 from a combination of generated designs and synthetic designs.

Once specifications are obtained, the present disclosure extracts features 506 from the specification. In an example implementation, any of the existing mechanisms can be used for extraction of the features from one or more NoC specifications, for example as disclosed in U.S. application Ser. No. 15/403,723, herein incorporated by reference in its entirety for all purposes. The vector of features extracted can represent a NoC. In an example implementation, the vector of features can represent a space of possible NoCs. In an example implementation, extracted features can be represented in the form of a bit vector. Alternatively, each of the extracted features can be identified and a vector can be created based on respective values thereof. In an example implementation, one vector of features is extracted from one NoC specification.

In a non-limiting example implementation, features can be extracted in a randomized manner, such as but not limited to, by extracting positions associated with hosts and bridges based on brute force method through selection of elements and their associated paths, by extracting connectivity information between nodes in the specification based on traffic flow between two nodes, by extracting topology by studying blockages, by extracting bandwidth requirements such as high, medium or low, form the design, by extracting data width information for each data link, by extracting frequency information (for example, each section can have different clock domains), by extracting details on layers as the number of layers can be different from design to design, by extracting grid sizes, say 10×10 mesh or 16×16 mesh, and so on. In an example, features extracted from the specification can have multiple sub-features associated with it. In an example, variants of a feature can also be extracted from the features derived from the specification.

In an example implementation, features and/or sub-features and/or variants of the features can be reduced or normalized by a feature selection method so as to retain only the required features form the set of features extracted. In an example implementation, features may be normalized to an extent during extraction due to projection mechanism (for example M4 and M60 projections).

In an example implementation, features extracted can be reduced by using any existing technique including, but not limited to, a principle component analysis (PCA) or a neural network, and the like. PCA tries to extract features that have the highest information when it is preliminary possible to extract a subset of features that are most significant or highest weighted. Neural network builds a narrow network so as to be shallow, and given one or more input features, only information on important aspects may be extracted. It may be understood that there can be different algorithms/techniques that can be applied in order to reduce features and all such algorithms/techniques can be used by the present disclosure.

In an example implementation, the present disclosure can perform different mapping strategies 508 on specification 504 so as to obtain NoC(s) 510. Any mapping strategy may be utilized, which can include, for example, mapping strategies described in U.S. application Ser. No. 15/403,162, herein incorporated by reference in its entirety for all purposes. In an example implementation, plurality of mapping strategies can include, but are not limited to, separation of request and response traffic on at least one of different links or virtual channels or layers, and separation of single and multibeast traffic on at least one of the different links or virtual channels or layers.

NoC(s) 510 so obtained can be further passed through a simulator in order to obtain metrics 512 associated with the NoC, wherein the metrics 512 can be obtained by implementing at least one mapping strategy selected from a set of mapping strategies 508. In an example implementation, quality metric(s) can be based on at least one of: a link cost or a flop cost or a latency cost or a bandwidth cost. In a non-limiting example implementation, metrics 512 can be associated with bandwidth and a cost, bandwidth and area, bandwidth and latency, among other like combinations. In an implementation, metrics 512 obtained may represent a real number that may be pre-stored/pre-defined/pre-configured for a particular metrics. For example, number 1 may represent bandwidth and cost metrics, number 2 may represent bandwidth and area metrics, and number 3 may represent bandwidth and latency metrics.

In an example implementation, features obtained (vectors of features obtained) 506, plurality of mapping strategies 508, and metrics 512 (number) obtained by implementing at least one strategy selected form a plurality of mapping strategies can be fed to a machine learning predictor 516. In one example implementation, features obtained (vectors of features obtained) 506, plurality of mapping strategies 508, and metrics 512 (number) obtained by implementing at least one strategy selected form a plurality of mapping strategies can be used for machine learning according to the present disclosure.

Upon feeding features (vectors of features obtained) 506, plurality of mapping strategies 508, and metrics 512 (number) that are obtained by implementing at least one strategy selected from a plurality of mapping strategies, the machine learning predictor 516 of the present disclosure utilizes at least one performance function 514, that may be pre-stored/pre-configured/ provided by the user based on his requirements or the design, to thereby provide output 524 in such a form that can enable determination of whether the NoC design finally obtained would actually be the most optimal and efficient one or not i.e., whether the design obtained is a good design or a bad design or not, and/or to provide an indication as to whether the set of strategies results in a good or bad design, or an indication as to whether the provided strategy meets a threshold for the quality metric, and suits the user requirement.

In an example implementation, machine learning predictor 516 can predict output 524 using a classifier and at least one performance function 514. In an example implementation, classifier is a specialized mechanism according to the present disclosure that receives input in terms of features obtained (vectors of features obtained), plurality of mapping strategies, and metrics (number) obtained by implementing at least one strategy selected from a plurality of mapping strategies and at least one performance function 514, and learns from the input and the output obtained from the implementations of the strategies for NoC construction and/or gets trained. Such learned/trained data can be used to classify as to whether the design is a good design or a bad design and/or to provide an indication as to whether the set of strategies results in a good or bad design, or an indication as to whether the provided strategy meets a threshold for the quality metric, and suits the user requirement. In an example implementation, such learned/trained data can be used to classify as to whether the design is a design that meets a quality threshold, or user requirements.

In an example implementation, classifier classifies designs into a class that provides a value. In an example, the value can be an arbitrary large value.

In an example implementation, classifier may utilize a trained data having a set of input values to predict an output value, where the output value can either be a classification value or a regression value. In an example implementation, the classifier may use any of the existing algorithms including, but not limited to, a random forest algorithm or a neural network algorithm, a multi-variant linear regression algorithm, vector machines, or pattern matching to classify a design as good design or bad design.

In an example implementation, for a particular feature and/or for a particular feature set and/or for a particular strategy set, the present disclosure can provide a specific number to a design that indicates if the design is a good design or a bad design. Such number can be pre-defined/ pre-configured/pre-stored. For example, number 0 can indicate a good design that can be obtained when a particular feature or a particular feature set or a particular strategy set is used, whereas number 1 can indicate a bad design when a particular feature, or a particular feature set, or a particular strategy set is used.

In an example implementation, when a new design for NoC is being fed, machine learning predictor 516 and specifically the classifier, maps the new design (along with features, metrics, and strategy to obtain the metrics) to a trained data set (using pattern matching information) in order to predict the output in terms of whether the new design is good or bad or is as per the users requirement. Thus, machine learning predictor 516 can provide an indication about the quality of design that is going to be produced given a feature and given a strategy. In an example implementation, machine learning predictor 516 can, given a feature as an input, indicate what strategy is going to yield the best result. In an example implementation, the machine learning predictor can provide an indication as to whether the set of strategies results in a good or bad design, or an indication as to whether the provided strategy meets a threshold for the quality metric, and suits the user requirement.

In an example implementation, when machine learning predictor 516 is fed with a strategy, it can decide whether it is going to work or not, and decide whether to use that strategy. In another example implementation, a subset of best results are fed into a NoC construction tool which then can build the subset of NoCs and picks the best one by running simulations on those subset of NoCs.

In an example implementation, machine learning predictor 516 can include a plurality of data sets such as a training data set 518, a validation data set 520, and a test data set 522, wherein the training data set 518, as discussed above, can be utilized for training machine learning predictor 516, whereas the validation data set 520 is similar to the training data set 518 but can additionally be used to learn and also use unique parameters from the features or strategies or metrics. For example, if one or more parameters in a classifier need to be tweaked, they can be tweaked using the validation data set 520. Test data set 522, on the other hand, provides actual output for the machine learning predictor 516 in order to classify the design as a good design or a bad design. In an example, when features and strategies are fed to the machine learning predictor 516, the test data set 522 can be utilized for comparison/pattern matching, and thereby classify the design as good design or bad design and/or to provide an indication as to whether the set of strategies results in a good or bad design or an indication as to whether the provided strategy meets a threshold for the quality metric.

In an example implementation, classifier classifies designs obtained for the NoC by utilizing at least one performance function 514 into a class that provides a value. In an example, the value can be an arbitrary large value. In an example, the present disclosure can build one classifier for each parameter selected form power, latency, area, or bandwidth. So, user can build one classifier which purely optimizes bandwidth or another one which purely optimizes link cost. Thus, the user can have different classifiers, and depending on the use case, the user can select the appropriate classifier. In another example, the present invention can build a combined classifier for each parameter selected from power, latency, area, or bandwidth.

In an example implementation, when machine learning predictor 516 is fed with a strategy and the performance function, it can decide whether it is going to work or not, and decide whether to use that strategy. In another example implementation, a subset of best results are fed into a NoC construction tool which then can build the subset of NoCs and picks the best one by running simulations on those subset of NoCs.

In an example implementation, performance function 514 can be based on at least one of a bandwidth function, a latency function, a cost function, or an area function. In an example implementation, performance function can be based on requirements of user as specified either in the specification or while designing and what the user is trying to optimize. For example, a user may require high bandwidth as his/her NoC may be used for high end communication systems. In such a scenario, the user may not be concerned about the cost of the system or the area of the system. However, in case if a user is cost-concerned, the user may concentrate his requirements on cost and/or area parameters/characteristics. In another example, if user cares equally about wires in combination with the number of flops, each one of the wires and the flop count can have a weight, and the total cost can be expressed as a combination of the wires and flop count.

In an example, bandwidth function can be dependent on bandwidth of the overall system, wherein the overall bandwidth of the system can be obtained by taking an average of the bandwidths across the system. In an example, bandwidth can be obtained based on specification provided, more specifically, the bandwidth associated with each of the agents in the specification.

In an example, cost function can be obtained based on area obtained from the specification. For example, number of wires indicative of the number of links can be used to find a link cost, whereas the number of loops in the design can be used to find buffer cost.

In an example, latency function can be obtained based on latency of the system. Latency can be obtained from average time for packets to move from source to destination. The latency function can generally be kept low in systems considering high packet deliverable ratios.

In an example, power function can be obtained based on activeness of each channel in the design. Generally, for an effective design, power function/requirement can always be considered to be low. Therefore, when channels are more active, it may indicate that more power would be consumed in the system.

In an example implementation, performance functions are based on user requirements from the system. For example, selection of power function or latency function or area function or bandwidth function can be decided by user based on his/her requirement from the system. For example, user may want to have high bandwidth and therefore the user may not have any concern with high area or cost for implementing the same. Thus, it may be noted and understood that performance function according to the present disclosure is dependent of user requirements from the NoC design.

In an example implementation, a NoC specification is processed by a machine learning process to generate a NoC by using at least one strategy selected from a plurality of NoC generation strategies. The generated NoC can be further utilized to generate graphs associated with the NoC behavior (e.g. bandwidth vs. latency graphs). Performance functions may be derived based on graphs generated. In an example, graphs can be obtained for multiple dimensions such as but not limited to latency, bandwidth, traffic etc associated with the NoC generated.

In an example implementation, performance function (Q) can be obtained based on following equation:

Q=(bandwidth)ⁱ/((cost)^{j}*(power)^{k}*(latency)^{m}) (1)

Where, i, j, k and m are desired factors.

In an example implementation, performance functions 514 are metrics used to train machine learning predictor 516. In an example, metrics can be or bandwidth and cost. Cost may be dependent on area that may consider parameters such as number of wires, link cost, number of flops or buffer cost, and so on. Each cost can have a weight, and the cost can have weighted combination of costs. In an example, metrics (Q) can be:

Q=(bandwidth)ⁱ/(cost)^{j} (2)

Where i and j are desired factors.

In an example implementation, performance function can also consider profiles such as but not limited to, traffic profile, power profiles, and the like for optimization of designs.

In an example implementation, performance function can optimize designs based on average case (e.g., average power, average bandwidth, average cost, average latency and so on), or per interface subset or traffic subset, or per profile such as traffic profile or power profiles, or the entire space (e.g., average power and average bandwidth and average cost and average latency and and so on).

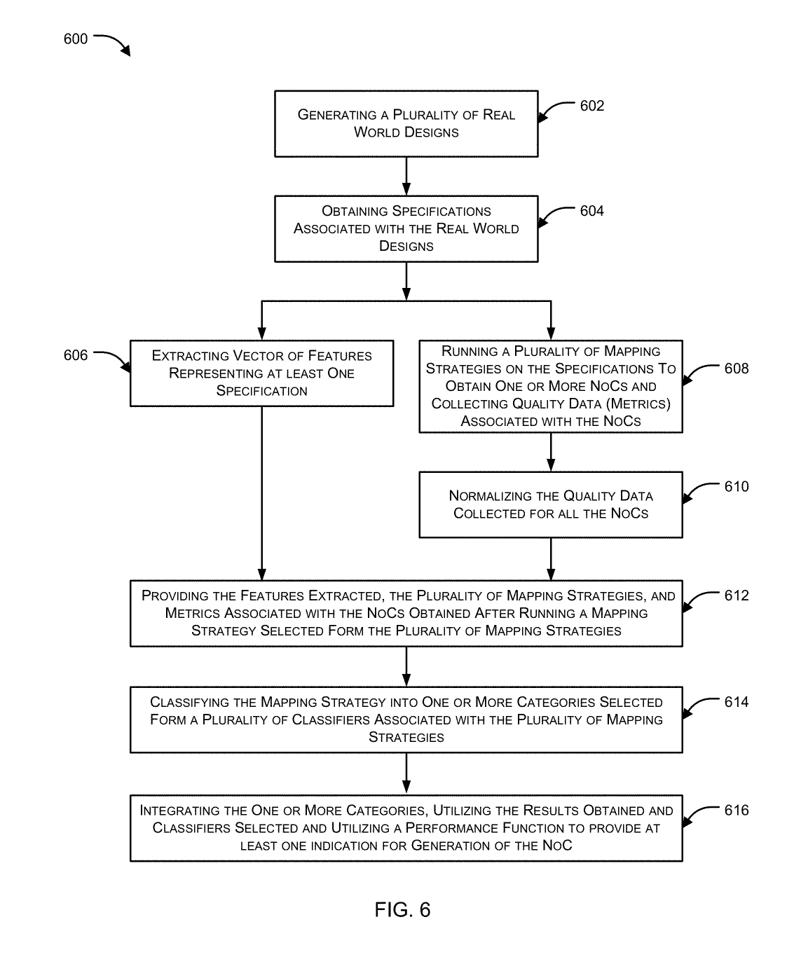

FIG. 6 illustrates an example process 600 for construction of a machine learning process for generating a Network on Chip (NoC) in accordance in accordance with an example implementation. In an example implementation, the present disclosure provides a machine learning algorithm/predictor that receives inputs in the form of features extracted from a specification, a plurality of mapping strategies, and a metrics (quality metrics) obtained by implementing a mapping strategy on the NoC so as to generate an output showing whether the selected strategy for the construction of the NoC actually yields a good result or a bad result and/or to provide an indication as to whether the set of strategies results in a good or bad design or an indication as to whether the provided strategy meets a threshold for the quality metric based on its learning/training.

In the example representation of FIG. 6, at 602, a plurality of real world designs is generated. Specifications associated with the real world designs can be obtained at 604, wherein features can be extracted from each specification at 606. In an example implementation, any of the existing mechanisms can be used for extraction of features from a given input specification. In an example implementation, a vector of features can be extracted from one or more NoC specifications. The vector of features extracted can represent a NoC. In an example implementation, the vector of features can represent a space of possible NoCs. In an example implementation, extracted features can be represented in the form of a bit vector. Alternatively, each of the extracted features can be identified, and a vector can be created based on respective values thereof. It is to be appreciated that such a proposed representation technique is completely exemplary in nature, and any other manner in which strategies can be selected using machine learning is completely within the scope of the present disclosure.

In a non-limiting example implementation, NoC specification parameters can be randomized, such as but not limited to, by extracting positions associated with hosts and bridges based on brute force method through selection of elements and their associated paths, by extracting connectivity information between nodes in the specification based on traffic flow between the two nodes, by extracting topology by studying blockages, by extracting bandwidth requirements such as high, medium or low, form the design, by extracting data width information for each data link, by extracting frequency information (for example, each section can have different clock domains), by extracting details on layers as the number of layers can be different from design to design, by extracting grid sizes say 10×10 mesh or 16×16 mesh, and so on. In an example, features extracted from the specification can have multiple sub-features associated with it. In an example, variants of the feature can also be extracted from the features derived from the specification.

At 608, a plurality of mapping strategies can be performed on the input specifications so as to obtain one or more NoCs and to collect quality data (metrics) associated with the NoCs by running a performance simulator. Quality data collected for the NoCs can be normalized at 610.

At 612, features extracted, plurality of mapping strategies, and metrics associated with the NoCs obtained after running a mapping strategy selected from the plurality of mapping strategies can be fed to machine learning predictor.

At 614, the machine learning predictor uses a classifier for classifying the mapping strategy into one or more categories selected from a plurality of classifiers associated with the plurality of mapping strategies.

At 616, the one or more categories can be integrated by the machine learning predictor, which utilizes results obtained, the selected classifier and at least one performance function in order to confirm whether the selected strategy meets the threshold of a certain criteria. In an example implementation, the one or more categories can be integrated by the machine learning predictor which utilizes results obtained and the selected classifier in order to confirm whether the selected strategy is good or bad and/or to provide an indication as to whether the set of strategies results in a good or bad design or an indication as to whether the provided strategy meets a threshold for the quality metric,

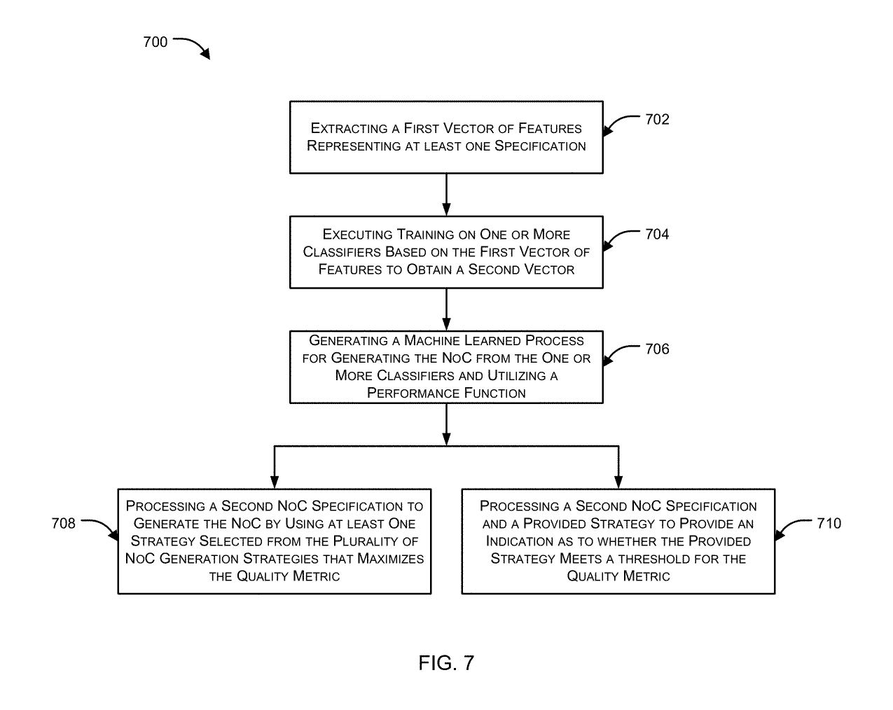

FIG. 7 illustrates an example method 700 for construction of a machine learning process for generating a Network on Chip (NoC) in accordance with an example implementation. This example process is merely illustrative, and therefore other processes may be substituted as would be understood by those skilled in the art. Further, this process may be modified, by adding, deleting or modifying operations, without departing from the scope of the inventive concept.

At 702, a first vector of features representing a NoC from one or more NoC specifications can be extracted, wherein the first vector of features is representative of a space of possible NoCs.

At 704, training on one or more classifiers can be executed based on the first vector of features so as to obtain a second vector, wherein the second vector can be indicative of a plurality of NoC generation strategies and of a quality metric. In an example implementation, a randomizing function can be applied to the first vector of features for generating each of the NoCs. In an example implementation, a quality metric can be based on at least one of a bandwidth function, a latency function, a cost function, or an area function.

In an example implementation, a database of generated NoCs is created, wherein each of the generated NoCs are associated with a validation based on quality metric, and further associated with a strategy selected from a plurality of NoC generation strategies. Further, the machine learning can be applied on the database of the generated NoCs so as to generate a machine learning process, wherein the machine learning process can be validated based on a subset of generated NoCs. Further, the machine learning process can be tested against another subset of the generated NoCs that are missing from the database.

At 706, a machine learning process can be generated for obtaining the NoC from one or more classifiers. Upon feeding the features obtained (vectors of features obtained), plurality of mapping strategies, and metrics (number) obtained by implementing at least one strategy selected form a plurality of mapping strategies, the machine learning predictor can provide an output in the form that can help confirm whether the NoC design finally obtained would be actually the most optimal and efficient one or not i.e., the design obtained is a good design or a bad design and/or to provide an indication as to whether the set of strategies results in a good or bad design or an indication as to whether the provided strategy meets a threshold for the quality metric. For confirming the design obtained as good design or bad design, the machine learning predictor utilizes the performance function.

In an example implementation, machine learning predictor 516 outputs results obtained from the classifiers which can be utilized by a NoC construction tool to generate a NoC upon which simulation can be performed by a simulation tool to extract evaluation metrics. In an example implementation, classifier classifies designs obtained for the NoC by utilizing at least one performance function into a class that provides a value. In an example, the value can be an arbitrary large value. In an example, the present disclosure can build one classifier for each parameter selected form power, latency, area, or bandwidth. So, user can build one classifier which purely optimizes bandwidth or another one which purely optimizes link cost. The user can have different classifiers, and depending on user requirements the classifier can be selected. In another example, the present invention can build a combined classifier for each parameter selected form power, latency, area, or bandwidth.

In an example implementation, machine learning predictor predicts output uses a classifier, which can be a specialized mechanism that can receive input in terms of the features obtained (vectors of features obtained), plurality of mapping strategies, and metrics (number) obtained by implementing the at least one strategy selected from a plurality of mapping strategies, and learns from the input and the output obtained from the implementations of the strategies for NoC constructions or gets trained. Such learned/trained data can be used to classify a design as good design or bad design and/or to provide an indication as to whether the set of strategies results in a good or bad design or an indication as to whether the provided strategy meets a threshold for the quality metric.

In an example implementation, the classifier can classify a design into a class. In another example implementation, the classifier may utilize a trained data having a set of input values to predict an output value, where the output value can either be a classification value or a regression value. In an example implementation, the classifier may use any of the existing algorithms such as but not limited to, a random forest algorithm or a neural network algorithm, a multi-variant linear regression algorithm, vector machines, pattern matching to classify the design as a good design or a bad design.

At 708, a second NoC specification can be processed to generate the NoC by using at least one strategy selected from a plurality of NoC generation strategies that maximize the quality metric.

At 710, a second NoC specification and a provided strategy can be processed to provide an indication as to whether the provided strategy meets a threshold for the quality metric.

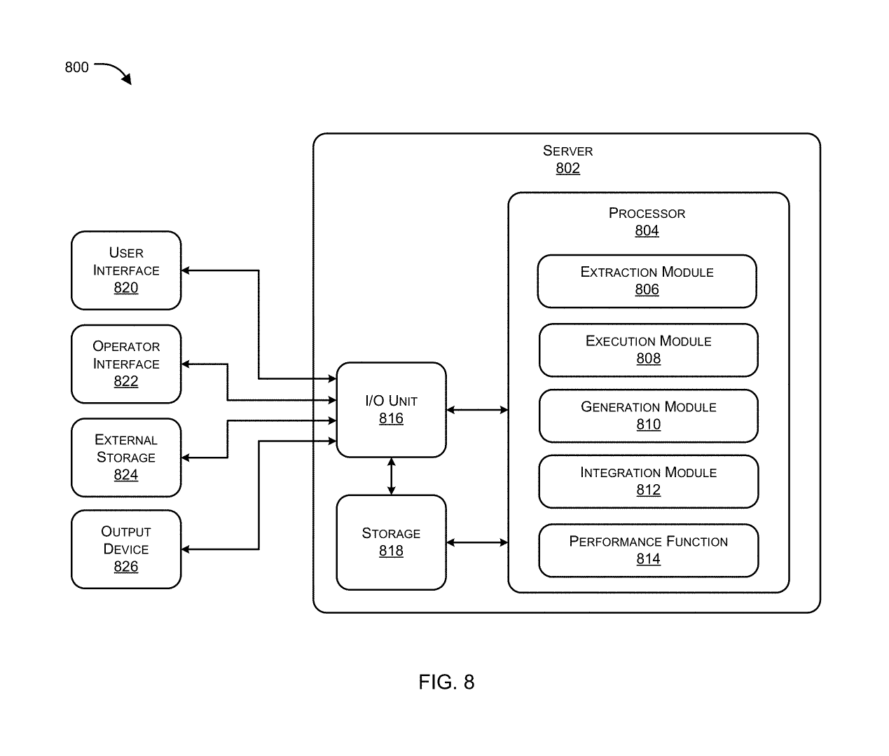

FIG. 8 illustrates an example computer system 800 on which example implementations may be implemented. This example system is merely illustrative, and other modules or functional partitioning may therefore be substituted as would be understood by those skilled in the art. Further, this system may be modified by adding, deleting, or modifying modules and operations without departing from the scope of the inventive concept.

In an aspect, computer system 800 includes a server 802 that may involve an I/O unit 816, storage 818, and a processor 804 operable to execute one or more units as known to one skilled in the art. The term “computer-readable medium” as used herein refers to any medium that participates in providing instructions to processor 804 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The I/O unit processes input from user interfaces 820 and operator interfaces 822 which may utilize input devices such as a keyboard, mouse, touch device, or verbal command

The server 802 may also be connected to an external storage 824, which can contain removable storage such as a portable hard drive, optical media (CD or DVD), disk media or any other medium from which a computer can read executable code. The server may also be connected an output device 826, such as a display to output data and other information to a user, as well as request additional information from a user. The connections from the server 802 to the user interface 820, the operator interface 822, the external storage 824, and the output device 826 may via wireless protocols, such as the 802.11 standards, Bluetooth® or cellular protocols, or via physical transmission media, such as cables or fiber optics. The output device 826 may therefore further act as an input device for interacting with a user.

The processor 804 can include an extraction module 806, an execution module 808, and a generation module 810 and a set of performance function 814, wherein the extraction module 806 can extract a first vector of features representing at least one NoC specification, and wherein the first vector of features is representative of a space of possible NoC specifications. The execution module 808, on the other hand, can execute training on one or more classifiers based on the first vector of features so as to obtain a second vector that is indicative of a plurality of NoC generation strategies and a quality metric. The generation module 810 can generate a machine learning process by utilizing at least one performance function 814 for generating the NoC from the one or more classifiers, wherein the generated machine learning process can process a second NoC specification so as to generate the NoC by using at least one strategy selected from the plurality of NoC generation strategies that maximizes the quality metric. The generated machine learning process can process the second NoC specification and a provide vector of strategies to present an indication as to whether the provided vector of strategies meets a threshold for the quality metric.

In an example implementation, the performance function can optimize the designs based on average case (e.g., average power, average bandwidth, average cost, average latency and so on), or per interface subset or traffic subset, or per profile such as traffic profile or power profiles, or the entire space (e.g., average power and average bandwidth and average cost and average latency and so on). In an example implementation, the performance functions are based on the user's requirement for the system. For example, the selection of the power function or the latency function or the area function or the bandwidth function can be decided by the user based on his requirement from the system. For example, the user may want to have high bandwidth so the user may not have any concern with high are or cost for implementing the same. Thus, it may be noted and understood that the performance functions according to the present disclosure are dependent of the user's requirement from the NoC design.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

1. A method, for construction of a machine learning process for generating a Network on Chip (NoC), the method comprising:
extracting, from one or more NoC specifications, a first vector of features of at least one NoC specification, the first vector of features representative of a space of possible NoC specifications;
executing training on one or more classifiers based on the first vector of features to obtain a second vector indicative of a plurality of NoC generation strategies and a quality metric; and
generating a machine learning process for generating the NoC from the one or more classifiers and by utilizing at least one performance function, the generated machine learning process is configured to, conduct at least one of:
process a second NoC specification to generate the NoC by using at least one strategy selected from the plurality of NoC generation strategies that maximizes the quality metric; or
process a second NoC specification and a provided vector of strategies to provide an indication as to whether the provided vector of strategies meets a threshold for the quality metric.

2. The method according to claim 1, wherein the quality metric is based on the performance function.

3. The method according to claim 1, wherein executing training on the one or more classifiers comprises:
generating a database of the NoCs generated, wherein each of the NoCs generated are associated with a validation based on the quality metric and a strategy from the plurality of NoC generation strategies; and
applying at least one machine learning on the database of the NoCs generated to generate the machine learning process.

4. The method according to claim 3, wherein generating the database of the NoCs generated comprises: applying a randomizing function to parameters of the NoC specification to generate the first vector of features for generating each of the NoCs.

5. The method according to claim 3, further comprising:
validating the machine learning process based on a subset of the NoCs generated from the database; and
testing the machine learning process against another subset of the NoCs generated missing in the database.

6. The method according to claim 1, further comprising:
integrating the machine learning process into a software tool configured to generate the NoC from a NoC specification.

7. The method according to claim 1, wherein the at least one performance function is based on at least one of a bandwidth function, a latency function, a cost function, and an area function.

8. A system, for construction of a machine learning process for generating a Network on Chip (NoC), the system comprising:
a processor, configured to:
extract, from one or more NoC specifications, a first vector of features of at least one NoC specification, the first vector of features representative of a space of possible NoC specifications;
execute training on one or more classifiers based on the first vector of features to obtain a second vector indicative of a plurality of NoC generation strategies and a quality metric; and
generate a machine learning process for generating the NoC from the one or more classifiers and by utilizing at least one performance function, the generated machine learning process configured to, conduct at least one of:
process a second NoC specification to generate the NoC by using at least one strategy selected from the plurality of NoC generation strategies that maximizes the quality metric; or
process the second NoC specification and a provided vector of strategies to provide an indication as to whether the provided vector of strategies meets a threshold for the quality metric.

9. The system according to claim 8, wherein the quality metric is based on the performance function.

10. The system according to claim 8, wherein the processor is further configured to:
generate a database of the NoCs generated, wherein each of the NoCs generated are associated with a validation based on the quality metric and a strategy from the plurality of NoC generation strategies; and
apply at least one machine learning on the database of the NoCs generated to generate the machine learning process.

11. The system according to claim 10, wherein the database is generated by applying a randomizing function to parameters of the NoC specification to generate the first vector of features for generating each of the NoCs.

12. The system according to claim 10, wherein the processor is further configured to:
validate the machine learning process based on a subset of the NoCs generated from the database; and
test the machine learning process against another subset of the NoCs generated missing in the database.

13. The system according to claim 8, wherein the processor is further configured to integrate the machine learning process into a software tool configured to generate the NoC from a NoC specification.

14. The system according to claim 8, wherein the at least one performance function is based on at least one of a bandwidth function, a latency function, a cost function, and an area function.

15. A non-transitory computer readable storage medium storing instructions for executing a process, the instructions comprising:
extracting, from one or more NoC specifications, a first vector of features representing at least one NoC specification, the first vector of features representative of a space of possible NoC specifications;
executing training on one or more classifiers based on the first vector of features to obtain a second vector indicative of a plurality of NoC generation strategies and a quality metric; and
generating a machine learning process for generating the NoC from the one or more classifiers and by utilizing at least one performance function, the generated machine learning process configured to, conduct at least one of:
process a second NoC specification to generate the NoC by using at least one strategy selected from the plurality of NoC generation strategies that maximizes the quality metric; or
process a second NoC specification and a provided vector of strategies to provide an indication as to whether the provided vector of strategies meets a threshold for the quality metric.

16. The non-transitory computer readable storage medium according to claim 15, wherein the quality metric is based on the performance function, wherein the at least one performance function is based on at least one of a bandwidth function, a latency function, a cost function, and an area function.

17. The non-transitory computer readable storage medium according to claim 15, wherein executing training on the one or more classifiers comprises:
generating a database of the NoCs generated, wherein each of the NoCs generated are associated with a validation based on the quality metric and a strategy from the plurality of NoC generation strategies; and
applying at least one machine learning on the database of the NoCs generated to generate the machine learning process.

18. The non-transitory computer readable storage medium according to claim 17, wherein generating the database of the NoCs generated comprises: applying a randomizing function to parameters of the NoC specification to generate the first vector of features for generating each of the NoCs.

19. The non-transitory computer readable storage medium according to claim 17, wherein, further comprising:
validating the machine learning process based on a subset of the NoCs generated from the database; and
testing the machine learning process against another subset of the NoCs generated missing in the database.

20. The non-transitory computer readable storage medium according to claim 15, wherein
integrating the machine learning process into a software tool configured to generate the NoC from a NoC specification.
